(19) United States
(12) Patent Application Publication
(10) Pub. No.: US 2022/0358519 A1
(43) Pub. Date: Nov. 10, 2022

(54) AUTHENTICATION SYSTEM

(71) Applicant: TAGD SOLUTIONS LIMITED, London (GB)

(72) Inventors: Leonardo Victor Alexander CLARKE, London (GB); Christopher Simon CLARKE, London (GB)

(21) Appl. No.: 17/762,947

(22) PCT Filed: Sep. 23, 2020
(86) PCT No.: PCT/GB2020/052311

§ 371 Date: Mar. 23, 2022

(30) Foreign Application Priority Data
Sep. 23, 2019 (GB) 1913679.5
Feb. 7, 2020 (GB) 2001708.3
Mar. 16, 2020 (GB) 2003802.2

(51) Int. Cl. G06Q 30/00

(52) U.S. Cl. CPC G06Q 30/0185

(57) ABSTRACT

An authentication system (201) with means to create a chain of association between a product (207), the manufacturer (217) of that product and a purchaser (211) and subsequent purchaser (261) of that product (207). The authentication system (201) has a generator for generating unique product identification codes (219, 233, 269, 273) and for linking them to the purchasers (211, 261) to enable verified transactions to be undertaken.

The present invention relates to a system for demonstrating the authenticity and ownership of a product throughout its lifecycle and to an authentication system that enables a manufacturer to monitor online sales transactions relating both to its authentic products, e.g. products that it has manufactured, and non-authentic versions of its products, e.g. counterfeits.

The authentication system of a first embodiment of the present invention is intended to hinder, rather than to eradicate, the sale of counterfeit goods. The authentication system is not intended to prevent intentional fraudulent activity, but it does make the activity of counterfeiting much more difficult and thus much less profitable for the counterfeiter, preferably to the extent that the counterfeiter decides not to take up, or to cease, counterfeiting activities.

The authentication system forces a counterfeiter to purchase a genuine product, so that they can commence an authentication chain that is facilitated by the authentication system. Consequently, the authentication system provides complete protection for a manufacturer's primary product sales (i.e. the first sales of new products). The protection of a manufacturer's primary sales is the key advantage offered by the authentication system of the first embodiment of the present invention. The authentication system of the first embodiment also offers increased protection to consumers against the purchase of counterfeit products, but this is a secondary advantage of the system.

If a possible counterfeit product is identified, for example by a subsequent purchaser, and then that product is identified as a counterfeit, for example by making an enquiry of the purported manufacturer, then the authentication system allows the seller, for example the initial reseller, to be identified. That seller would have incriminated themselves in the illegal act of knowingly selling a counterfeit product. The system would have the contact details, e.g. postal address, telephone number, e-mail address, of the person committing the illegal act, thus rendering them easy to contact.

The authentication system of a second embodiment of the present invention is intended to both hinder and eradicate the sale of counterfeit goods. The authentication system is intended to prevent intentional, larger scale, fraudulent activity, although instances of such activity are likely to persist under some circumstances. The authentication system does this by making the activity of counterfeiting much more difficult and far less profitable for the counterfeiter, preferably to the extent that the counterfeiter decides not to take up, or to cease, counterfeiting activities.

The authentication system forces a counterfeiter to purchase a genuine product, so that they can commence an authentication chain that is facilitated by the authentication system. Consequently, the authentication system provides complete protection for a manufacturer's primary product sales (i.e. the first sales of new products). The authentication system is thus able to significantly diminish a counterfeiter's ability to sell on a counterfeit product, when that counterfeiter is acting as an initial reseller (i.e. they are acting as the first person to sell the product after the primary product sale). The protection of a manufacturer's primary sales and the provision of increased protection to consumers against the purchase of counterfeit products are the key advantages offered by the authentication system of the second embodiment of the present invention.

Where an initial reseller is suspected of undertaking counterfeiting activity (whether that is small scale, large scale or industrial scale) it is advantageous to be able to prevent any further counterfeiting activities.

It is also advantageous to be able to control the types of products that can be re-sold, the quantities of a particular product that can be resold, the locations in which re-selling can take place and the timeframes for re-sales.

Moreover, if a possible counterfeit product is identified, for example by a subsequent purchaser, and then that product is identified as a counterfeit, for example by making an enquiry of the purported manufacturer, then the authentication system allows the seller, for example the initial reseller, to be identified. That seller would have incriminated themselves in the illegal act of knowingly selling a counterfeit product. The system would have the contact details, e.g. postal address, telephone number, e-mail address, of the person committing the illegal act, thus rendering them easy to contact and/or prosecute.

The authentication system of the third embodiment of the present invention utilises unique codes that are associated with individual products and it works in collaboration with merchant payment systems. The authentication system of the third embodiment communicates with a merchant payment system when it becomes aware of the initiation by an online seller of an online sales transaction, relating to either a verified product, i.e. a product that has been verified as authentic, or an unverified product, i.e. a product that may or may not be authentic. If the online seller is able to respond to the merchant payment system's request for a unique code that has been associated with the product, then the merchant payment system will authorise the transaction. If the online seller cannot provide the merchant payment system with the unique code then the merchant payment system will not authorise the transaction.

In this way the manufacturer can monitor the sales of verified products being made by its online retail partners, it can monitor the sales of unverified products being made by its online retail partners and it can monitor the sales of unverified products being made by online retailers with whom the manufacturer has no relationship.

The identification by the authentication system of sales of unverified products provides the manufacturer with the information that they need in order to take appropriate action, such as termination of a retail partnership, should they find that a retail partner is selling counterfeit products.

According to the present invention there is provided an authentication system comprising: a unique Manufacturer's Product Identification Code (MPIC) containing information to identify a unique product of a plurality of products; a unique purchaser code containing information to identify an individual purchaser of a plurality of purchasers, that information relating to the individual purchaser's mode of payment; a combined code generator for generating a unique combined code; an authentication database for receiving and storing product information identifying a unique product and for receiving and storing a unique purchaser code, both the product information and the unique purchaser code associated with the sale of a unique product and recorded in a sales receipt; a unique combined code request interface; a purchaser code database for receiving and storing the unique purchaser code relating to a purchaser's mode of payment; an authenticator for authenticating requests for unique combined codes, the authenticator capable of authenticating a request from a purchaser for a unique combined code that contains information from the MPIC that is associated with an individual product of a plurality of products purchased by an individual purchaser of a plurality of purchasers and information from the purchaser code of the individual purchaser, the unique combined code known as an Initial Purchaser's Product Identification Code (IPPIC), the authenticator being connected to the authentication database, to the combined code request interface and to the purchaser code database and comprising a comparator, wherein to authenticate a request for a IPPIC the comparator compares information within the MPIC provided by the purchaser, via the code request interface, with the product information associated with the sales receipts as stored in the authentication database, in order to find a match with a product code contained within a sales receipt thereby to identify the relevant product, wherein the comparator then compares the purchaser code for that sales receipt with the purchaser code element for the purchaser as contained in the purchaser code database; and if the comparator finds that the purchaser code for the sales receipt matches the purchaser code for the purchaser making the request for the IPPIC then the combined code generator will generate the IPPIC and the authentication system will issue it to the purchaser.

Preferably, the authenticator is capable of authenticating a request from a purchaser for an Initial Re-seller's Product Identification Code (IRPIC) made via the unique combined code request interface, the purchaser entering the IPPIC for the relevant product into the unique combined code request interface, wherein to authenticate the request for the IRPIC the comparator compares the purchaser code within the IPPIC with the purchaser code for the purchaser that is stored in the purchaser code database and if the purchaser code within the IPPIC and the purchaser code within the purchaser code database match then the combined code generator will generate the IRPIC and the authentication system will issue the IRPIC to the purchaser.

In the second embodiment of the present invention, the Initial Re-seller's PIC will be provided in an inactive form and will be activated if a data analyser determines that the initial re-seller's activity on a linked online selling platform meets the necessary criteria. If the initial re-seller's activity does not meet the necessary requirement then the Initial Re-seller's PIC will not be activated. The requirement placed on an initial re-seller to link their online selling account with the authentication system and the authentication system's ability to determine the activation of Initial Re-seller PICs affords it hypercritical control over a suspected counterfeiter's ability to, for example, sell a counterfeited version of a genuine product with an Initial Re-seller's PIC that has been obtained by purchasing a genuine product.

Additionally, in the second embodiment, the authentication system's ability to determine the activation of Initial Re-seller PICs affords it unlimited control (for example, at the behest of the manufacturer of the genuine primary product) over which products can be re-sold, the quantities in which products can be re-sold, the locations from which products can be re-sold and the timeframes in which products can be re-sold. The authentication system could, for example, block the activation of Re-seller PICs for all products within a territorial region or country where counterfeiting is prevalent and/or suspected. The authentication system's ability to determine these outcomes further reduces and hinders counterfeiting activity.

In addition, it is preferable that the authentication system further comprises a re-selling interface for interacting with a re-selling platform; wherein the authenticator is capable of authenticating a request for a verification of an IRPIC made by the re-selling platform via the re-selling interface, wherein to authenticate the request for a verification of an IRPIC the comparator first compares the purchaser code within the IRPIC with the purchaser code for the purchaser that is provided to the re-selling platform and second compares the product information provided to the authentication system by the re-selling platform with the product information in the IRPIC and if there is match for both the purchaser information and the product information then the authentication system will authenticate the verification request received from the re-selling platform.

Preferably, the combined code generator comprises a string generator for generating the unique combined codes.

Preferably, the combined code generator further includes a transmitter for transmitting a unique combined code generated by the combined code generator to a purchaser or to a re-seller.

Preferably, the authentication system further comprises a purchaser code generator, wherein the purchaser code generator generates a purchaser code by automatically redacting numbers from the identifying number for the purchaser's means of payment.

Preferably, the authentication system further comprises a re-seller code generator, wherein the re-seller code generator generates a re-seller code by automatically redacting numbers from the identifying number for the re-seller's means of payment.

Preferably, the authentication system further comprises a Manufacturer's Product Identification Code (M PIC) generator for generating a unique MPIC for a product.

Alternatively, the MPIC can be a manufacturer's pre-existing serial number. The ability for the manufacturer to use their pre-existing coding system can be advantageous in improving the ease with which the authentication system of the present invention can be implemented in practice.

Preferably, the authentication system further comprises a payment receipt interface, wherein, in use, a purchaser or re-seller can use the payment receipt interface to make a payment to the authentication system.

Preferably, the authentication system further comprises a sales interface, wherein in use, a retailer can use the sales interface to provide the MPIC and the purchaser code directly to the authentication database.

Preferably, the authentication system further comprises an electronic sales receipt generator.

Preferably, the authentication system further comprises a user account generator for generating a user account for a purchaser.

Preferably, the authentication database is located on a cloud based server.

Preferably, the authentication system is located on a cloud based server.

Preferably, the re-selling platform is an online selling platform.

According to the third embodiment of the present invention there is provided an online transaction monitoring system comprising a user account module, a code generation module, an invoice generation module, a sales listing module, a database, a verified online retailer data analyser that is connectable to a verified online retailer website and that is linked to the sales listing module by a data connection, an external entity interface module, a computer processor, a merchant payment system interface that is linked to each of the database and the sales listing module by a data connection and wherein the merchant payment system interface (59) is connectable to a merchant payment system.

Preferably, the online transaction monitoring system has a user account module that comprises a user account generator and a retailer ordering portal, a code generation module that comprises a PIC generator and a user code generator, an invoice generation module that comprises an invoice generator and a sales listing module that comprises a sales listing generator and a sales listing interface.

Preferably, the online transaction monitoring system further comprises a sales listing data analyser.

Preferably, the online transaction monitoring system has a database that contains a unique manufacturer product identification code and a unique verified product identification code (VRPIC), wherein the VRPIC contains information to identify a unique verified product.

### FIGURES

FIG. 1 is a schematic drawing showing an overview of the authentication system of the first embodiment of the present invention;

FIG. 2 is a schematic drawing showing the creation and allocation of a Manufacturer's Product Identification Code (MPIC), a transaction between an original retailer and an initial purchaser and the creation and allocation of an Initial Purchaser's Product Identification Code according to the first embodiment of the present invention;

FIG. 3 is a schematic drawing showing the creation and allocation of an initial re-seller's product identification code, the creation of a sales listing with an online selling platform, a subsequent sale and the creation of a Subsequent Purchaser's Product Identification Code and a Subsequent Re-seller's Product Identification Code according to the first embodiment of the present invention;

FIG. 4 is a further schematic drawing of the authentication system according to the first embodiment of the present invention;

FIG. 5 is a schematic drawing showing an overview of the authentication system of the second embodiment of the present invention;

FIG. 6 is a schematic drawing showing the creation and allocation of a Manufacturer's Product Identification Code (MPIC), a transaction between an original retailer and an initial purchaser and the creation and allocation of an Initial Purchaser's Product Identification Code according to the second embodiment of the present invention;

FIG. 7 is a schematic drawing showing the creation and allocation of an initial re-seller's product identification code, the creation of a sales listing with an online selling platform, a subsequent sale and the creation of a Subsequent Purchaser's Product Identification Code and a Subsequent Re-seller's Product Identification Code according to the second embodiment of the present invention;

FIG. 8 is a further schematic drawing of the authentication system according to the second embodiment of the present invention; and

FIG. 9 is a schematic diagram of the authentication system according to the third embodiment of the present invention illustrating the components of the system and the data connections via which they interact.

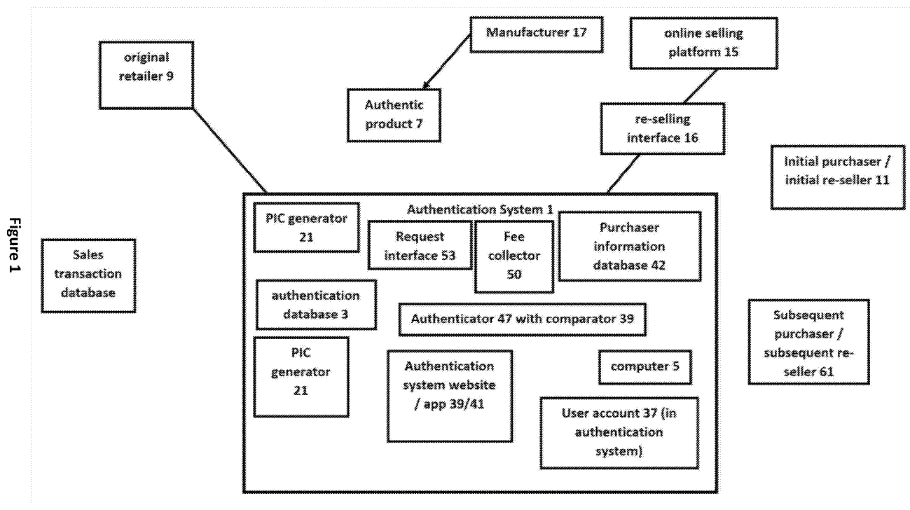

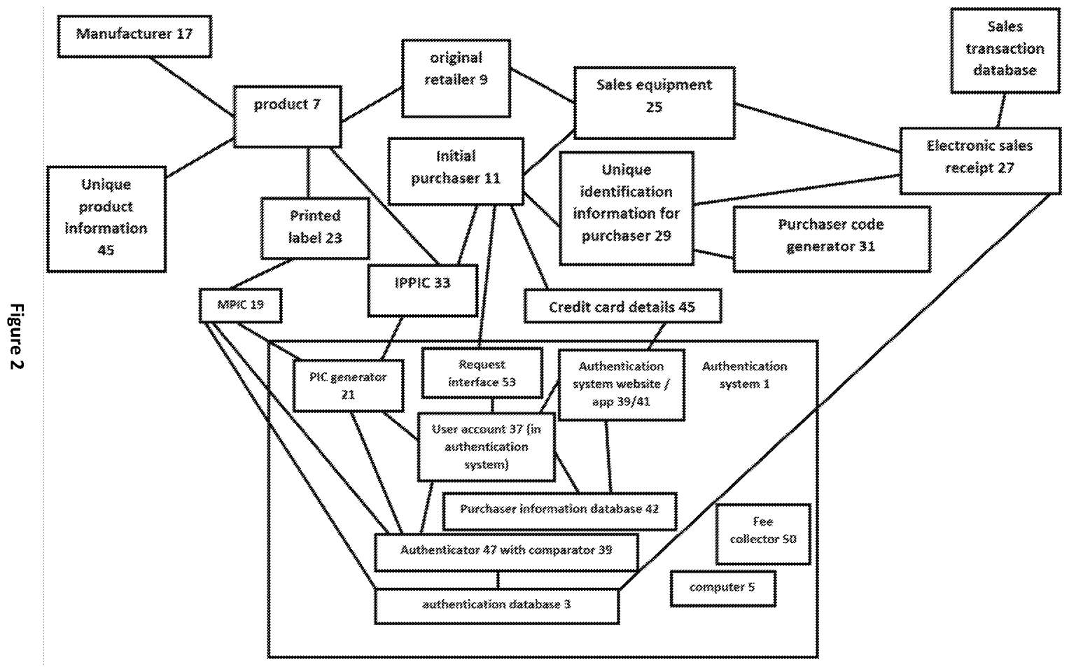

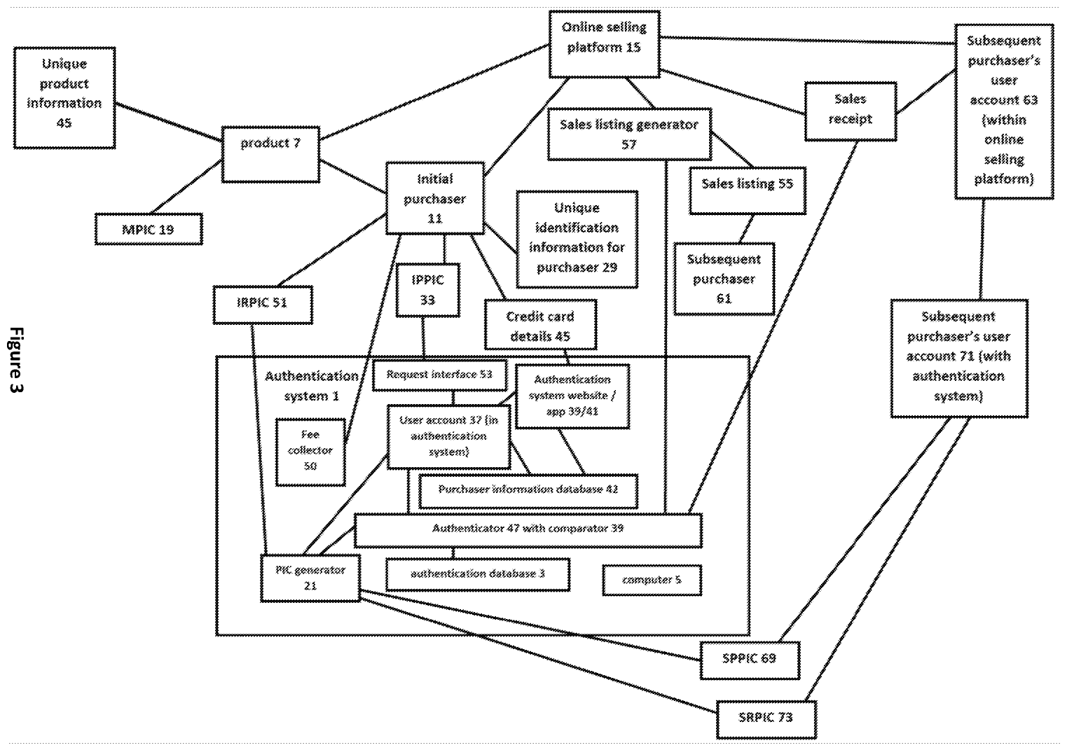

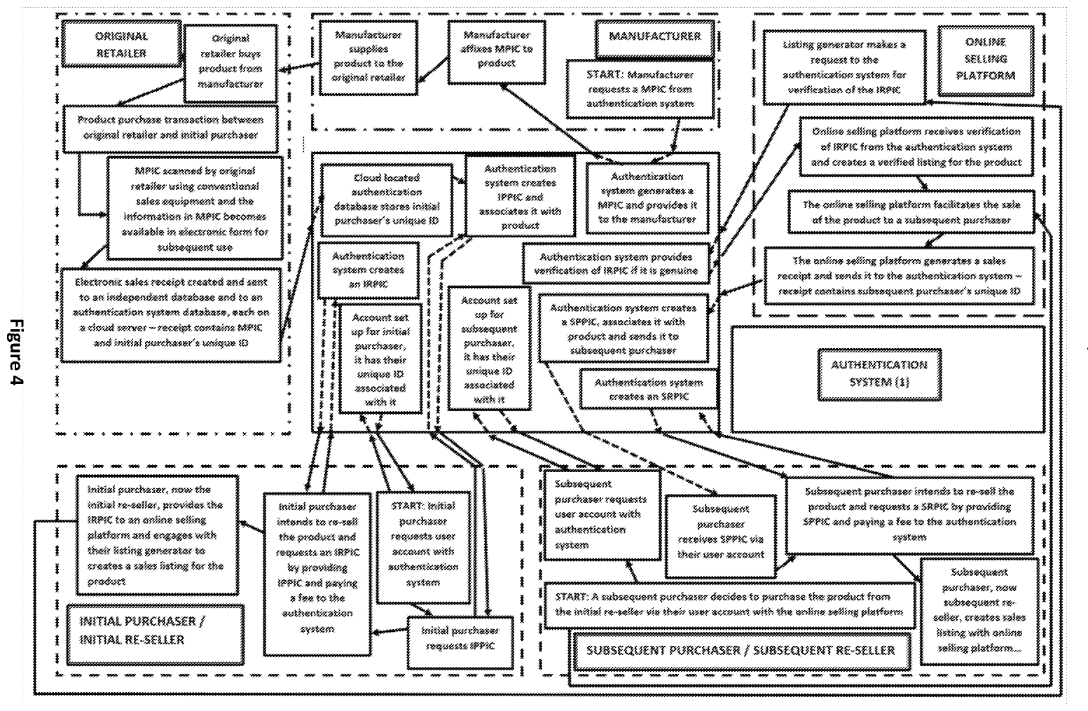

The authentication system 1 according to the first embodiment of the present invention is shown in FIGS. 1, 2, 3 and 4. The authentication system 1 includes a database 3 and an operating system that is implemented by a central computer 5 that is located remotely to the entities interacting with the authentication system. The entities are each provided with an interface into which they can enter information for use by the authentication system 1 and from which they can receive information produced by the authentication system 1. The interface can be provided on a website or on an app.

This first embodiment of the invention described here involves six discrete entities and the authentication system 1 itself. The authentication system 1 permits the tracking of transactions associated with an authentic product 7 throughout the life of that authentic product 7, from the time of the completion of its manufacture, through a first sale transaction, between an original retailer 9 and an initial purchaser 11, to any subsequent re-sale of the product by the initial purchaser 11 to a subsequent purchaser 13 via on online selling platform 15 that is linked to the authentication system by a re-selling interface 16.

The process starts with a manufacturer 17 manufacturing a product 7. The manufacturer 17, upon completion of manufacture, allocates to that product 7 a unique Manufacturer's Product Identification Code, otherwise known as a Manufacturer's PIC (or MPIC) 19. The Manufacturer's PIC 19 is generated by a product identification code generator 21 which is a component part of the authentication system 1. The Manufacturer's PIC 19 is unique to the product 7 and is affixed to it using a printed label 23 (or it may be inscribed or stamped into the product 7).

The manufacturer 17 supplies the product 7 to an original retailer 9 and subsequently the original retailer 9 transacts a sale of the product 7 to an initial purchaser 11. The Manufacturer's PIC 19 is swiped or scanned during the transaction, using the original retailer's normal sales equipment 25, so that the information contained in the Manufacturer's PIC 19 becomes available in an electronic form for subsequent use. The transaction creates an electronic sales receipt 27 which includes detailed information about the product 7 that has been sold, the Manufacturer's PIC 19, unique identification information 29 for the purchaser 11 unique to the initial purchaser 11, such as their credit card number with some digits redacted, and information stating that the sold product is a product authenticated by the authentication system. The redaction of numbers from the credit card number is undertaken automatically by a purchaser code generator 31. This electronic sales receipt 27 is automatically transmitted to a sales transaction database that is not part of the authentication system 1, for example an independent database stored on a cloud server. In addition the electronic sales receipt 27 is transmitted to a cloud based authentication database 3 of the authentication system 1, because the software of the original retailer's normal sales equipment 25 has recognised that the sales receipt 27 relates to a product 7 with a Manufacturer's PIC 19 and that is being sold in associated with the authentication system 1. The authentication system 1 responds by storing the unique identification information 29 for the purchaser 11 and the Manufacturer's PIC 19 in its authentication database 3 and by creating a new code called an Initial Purchaser's PIC (IPPIC) 33 utilising the product identification code generator 35. The Initial Purchaser's PIC 33 is associated with the product 7 and replaces the Manufacturer's PIC 19. The Manufacturer's PIC 19 is then defunct and it is not used for any subsequent transactions during the life of the product 7, unless the product 7 has been gifted, or transferred, as dealt with later in this description. The Initial Purchaser's PIC 33 is not provided to the manufacturer 17 or to the original retailer 9 associated with the transaction, but it can be provided to the initial purchaser 11, as will be explained below.

If the initial purchaser 11 wants to verify that the purchased product 7 is genuine and/or if the initial purchaser 11 is minded to sell the product 7 in the future, then the initial purchaser 11 can actively engage with the authentication system 1 by opening a user account 37 on the authentication system 1, for example via the authentication system's website 39, or more usually via the authentication system's app 41. To create the user account 37 the initial purchaser 11 submits their credit card details 45, i.e. personal information that uniquely identifies them. That unique identification information 29 for the purchaser 11 is stored in a purchaser information database 42 within the authentication system 1.

Once the initial purchaser 11 has a user account 37 they can request the Initial Purchaser's PIC 33 by using the request interface 53. To obtain the Initial Purchaser's PIC 33 the authentication system 1 already has the Initial Purchaser's ID information 29 because the initial purchaser 11 provided their credit card details 43 when setting up their user account 37 with the authentication system 1. The unique product information 45 is obtained by use of an authenticator 47 which is a component of the authentication system 1. The authenticator 47 analyses the Manufacturer's PIC 19 and identifies the information that identifies that unique product 7. That information is typically a unique serial number. The authentication system 1 now has a first set of information relating to both the initial purchaser 11 and the product 7. The authentication system 1 now interrogates the electronic sales receipts 27 within the authentication database 3 to find a match for the unique product 7. The matched sales receipt 27 will also contain the personal identification information 29 for the purchaser 11. A comparator 49 connected to the authenticator 47 compares the initial purchaser's personal identification information 29, as provided directly to the authentication system 1 by the initial purchaser 11 when setting up their user account 37, with the initial purchaser's personal identification 29 as contained within the electronic sales receipt 27 that was sent to the authentication database 3 as a result of the initial sales transaction with the original retailer 9. If the comparison finds that the two sets of initial purchaser's identification information 29 match then the authentication system 1 will transmit an Initial Purchaser's PIC 33 to the initial purchaser 11 using a transmission device 30, such as the internet. The Initial Purchaser's PIC 33 enables the initial purchaser 11 to subsequently obtain an Initial Re-seller's PIC (IRPIC) 51, as will be explained below. The Initial Purchaser's PIC 33 thus includes the specific credit card payment system information 29 for the initial purchaser 11 that was used in the original transaction.

If the initial purchaser 11 decides that they wish to sell their product 7 then they will apply to the authentication system 1 for an Initial Re-seller's PIC 51. The initial purchaser 11 then becomes the initial re-seller 11. The initial re-seller 11 enters their Initial Purchaser's PIC 33 into the request interface 53 of the authentication system 1. The authenticator 47 in the authentication system 1 identifies the unique identification information 29 for the initial purchaser 11v that is contained in the Initial Purchaser's PIC 33 and using the comparator 49 compares it with the initial purchaser's identification information 29 stored in the initial purchaser's user account 37 with the authentication system 1. If the two sets of purchaser identification information 29 match and the initial re-seller 11 has paid a fee to the authentication system 1 using a fee collector 50, then the authentication system 1 will provide the initial re-seller 11 with the Initial Re-seller's PIC 51. The initial re-seller 11 can then engage with an online selling platform 15 to create a listing 55 using a sales listing generator 57 in order to advertise the product 7 for sale. A chain has now been formed between the Manufacturer's PIC 19, the Initial Purchaser's PIC 33 and the Initial Re-seller's PIC 51, such that only the initial purchaser/the initial re-seller 11 could be in possession of and/or have access to the Initial Re-seller's PIC 51. The initial purchaser 11 and the initial re-seller 11 are in many cases the same person/entity, but the authentication system 1 can deal with instances in which they are separate entities or people, for example if the product 7 has been purchased as a gift. That situation is explained in a separate section of this description provided below.

The sales listing generator 57 of the online selling platform 15 interacts with the authenticator 47 of the authentication system 1. During the creation of the sales listing 55, the sales listing generator 57 will request that the initial re-seller 11 enters their Initial Re-seller's PIC 51. The sales listing generator 57 will interact with the authentication system 1 and send the IRPIC 51 to the authentication system 1 in order to verify if the Initial Re-sellers's PIC 51 is genuine. Verification is made of both the initial re-seller's identification information 29 and the unique product information 45. In relation to the initial re-seller's identification information 29, the authenticator 47 in the authentication system 1 will identify the unique identification information 29 for the initial re-seller 11 that is contained within the IRPIC 51 and using the comparator 49 compare it with the initial re-seller's identification information 29 that is stored in the initial re-seller's user account 59 with the online selling platform 15. If the two sets of re-seller's information 29 are the same then the first stage of the verification is complete. The second stage is to check the product information in the sales listing 55 against the unique product information 45 in the IRPIC 51. If the product information matches then the authentication system 1 will inform the online selling platform 15 that the IRPIC 51 is genuine. The listing 57 will become a verified listing, i.e. the listing 57 is for being made by an entity that has previously purchased a genuine product 7 of the type being advertised for sale.

If a subsequent purchaser 61 is found for the product 7 via the sales listing 55 then the initial re-seller 11 will transact a sale with the subsequent purchaser 61, via the online selling platform 15. Typically, the subsequent purchaser 61 will pay for the product 7 using a pre-registered credit or debit card, or with another form of payment, such as a PayPal account. This is information that is already associated with the online selling platform user account 63 of the subsequent purchaser 61. The online selling platform 15 will generate a sales receipt 65. The sales receipt 65 will include the subsequent purchaser's credit card, debit card, or other payment method information 67, with some information redacted, e.g. some of the credit card numbers, and the subsequent purchaser's resale account information, e.g. name, telephone number and/or e-mail address (i.e. information sufficient to meet required identification criteria). The online selling platform 15 will interact with the authentication system 1 by sending the sales receipt 65 to the authentication system 1. The authentication system 1 will respond by creating a Subsequent Purchaser's PIC (SPPIC) 69. The Subsequent Purchaser's PIC 69 replaces the Initial Re-seller's PIC 51 and the Initial Re-seller's PIC 51 is defunct.

If the subsequent purchaser 61 has a user account 71 with the authentication system 1, then that user account 71 can be linked with the subsequent purchaser's online selling platform account 63 to enable the Subsequent Purchaser's PIC 69 to be sent automatically to the subsequent purchaser 61 (and to no-one else). The Subsequent Purchaser's PIC 69 will then have the details of the product 7, the transaction history and the personal identification information 67 for the current owner (i.e. the subsequent purchaser 61). The Subsequent Purchaser's PIC 69 does not become active until the subsequent purchaser's user account 63 with the online selling platform 15 is linked with the subsequent user's user account 71 with the authentication system 1. If the subsequent purchaser 61 does not have an account with the authentication system 1 then the Subsequent Purchaser's PIC 69 is sent to the subsequent purchaser 61, for example via e-mail as part of their electronic sales receipt 65. The Subsequent Purchaser's PIC 69 only becomes active when the Subsequent Purchaser 61 downloads the authentication system app 41 and links their authentication system user account 71 to their user account 63 on the online selling platform 15. If the subsequent purchaser 61 already has a user account 71 in the authentication system 1 that is linked to their online selling platform account 63 then the process is simplified because the transaction is automatically associated with the subsequent purchaser's two user accounts 63,71. An active version of the Subsequent Purchaser's PIC 69 would be generated and issued to the subsequent purchaser 61 using the authentication system 1.

If the subsequent purchaser 61 does not have a user account 71 with the authentication system 1, then an incomplete and inactive version of the Subsequent Purchaser's PIC 69 is provided to the subsequent purchaser 61 as part of the electronic sales receipt 65. The Subsequent Purchaser's PIC 69 can be completed and made active, for example to enable use for future re-selling activity, by the subsequent purchaser 61 obtaining a user account 71 for the authentication system 1 and by entering their personal identification information 67 and/or by linking that authentication system user account 71 to their user account 63 for the online selling platform 15.

The Subsequent Purchaser's PIC 69 provides to the subsequent purchaser 61 a verification that they are the rightful owner of the authentic version of the product and it enables the subsequent purchaser 69 to subsequently obtain a Subsequent Re-seller's PIC 73.

The Subsequent Re-seller's PIC 73 is used in the same way as the Initial Re-sellers PIC 51, such that numerous sales of a product 7 can occur throughout a product's life whilst all the time being able to maintain a chain of ownership back to the initial purchaser 11 of a genuine product 7.

If the initial purchaser 11 and the initial re-seller 11 are not the same person, for example the initial purchaser 11 has bought the product 7 as a gift for another person, then the person to whom the product 7 has been gifted can engage with the authentication system 1 if they wish to, for example to obtain an Initial Re-seller's PIC 51. The initial purchaser 11 will need to have a user account 37 with the authentication system 1 and using that user account 37 they will facilitate the generation of the Initial Purchaser's PIC 33, because the authentication system 1 will have the product details 45 and the personal identification details 29. The person to whom the product 7 has been gifted, referred to from now on as the transferee, will also need to have a user account with the authentication system 1 and they can, through that user account, request a product transfer by entering the Manufacturer's PIC 19 into the authentication system 1. The authentication system 1 will then ask the initial purchaser 11 to confirm that the product transfer has taken place.

In the preferred embodiment described above, the initial purchase of the new product 7 is made in a physical store, e.g. a shop on a high street. Alternatively, the initial purchase could be made in an online store, as will be explained below.

The initial purchaser 11 will buy a product 7 from an online store using a credit card, or an online payment system such as PayPal. The transaction generates a sales receipt 27 which includes the initial purchaser's credit card or online payment system account details 29, with various pieces of information redacted, and the initial purchaser's contact details, e.g. name, postal address, telephone number and e-mail address. The sales receipt 27 is sent to the authentication system 1 and thus the authentication system 1 receives the payment details, e.g. credit card details. The Initial Purchaser's PIC 33 is generated and if the initial purchaser 11 has a user account 37 with the authentication system 1 then the Initial Purchaser's PIC 33 is sent to that user account 37. The Initial Purchaser's PIC 33 does not become active until the user account 37 in the authentication system 1 and the user account in the online store are linked. If the Initial Purchaser 11 does not have a user account 37 with the authentication system 1 then the Initial Purchaser's PIC 33 is sent to the initial purchaser 11 with the sales receipt 27, e.g. by e-mail. The Initial Purchaser's PIC 33 becomes active when the initial purchaser 11 opens a user account 37 with the authentication system 1 and links it to the online store user account. If the initial purchaser 11 already has a user account 37 in the authentication system 1 that is linked to their online selling platform account then the process is simplified because the transaction is automatically associated with the initial purchaser's two user accounts. An active version of the Initial Purchaser's PIC 33 would be generated and issued to the initial purchaser 11 using the authentication system 1.

In an alternative arrangement, there is no need to make a link between the user account 37 in the authentication system 1 and the user account in the online store in order for the initial purchaser 11 to obtain an active Initial Purchaser's PIC. If the initial purchaser 11 does not have a user account 37 with the authentication system 1 the initial purchaser can purchase the product 7 online, receive it and subsequently obtain a user account 37 with the authentication system 1, enter the Manufacturer's PIC 19 via the website or app 39,41 and then obtain the IPPIC 33.

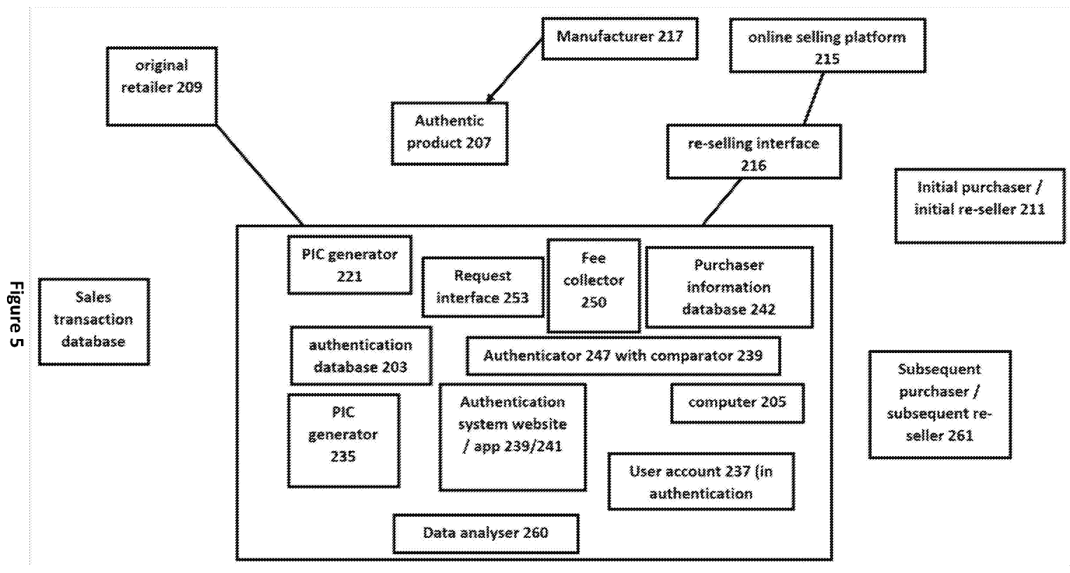

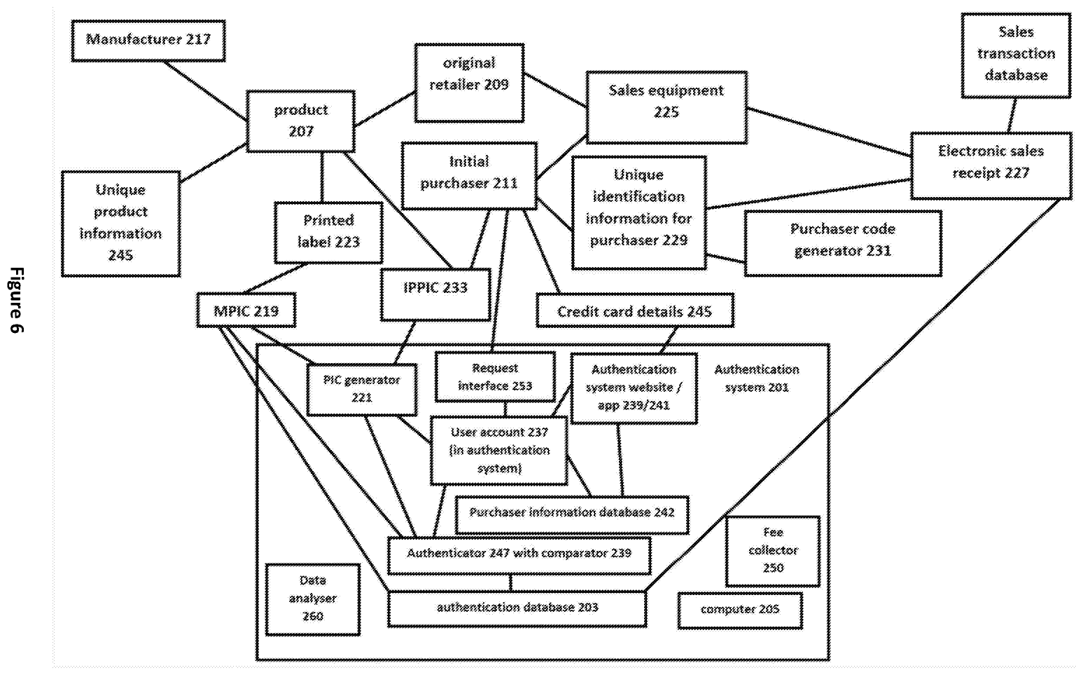

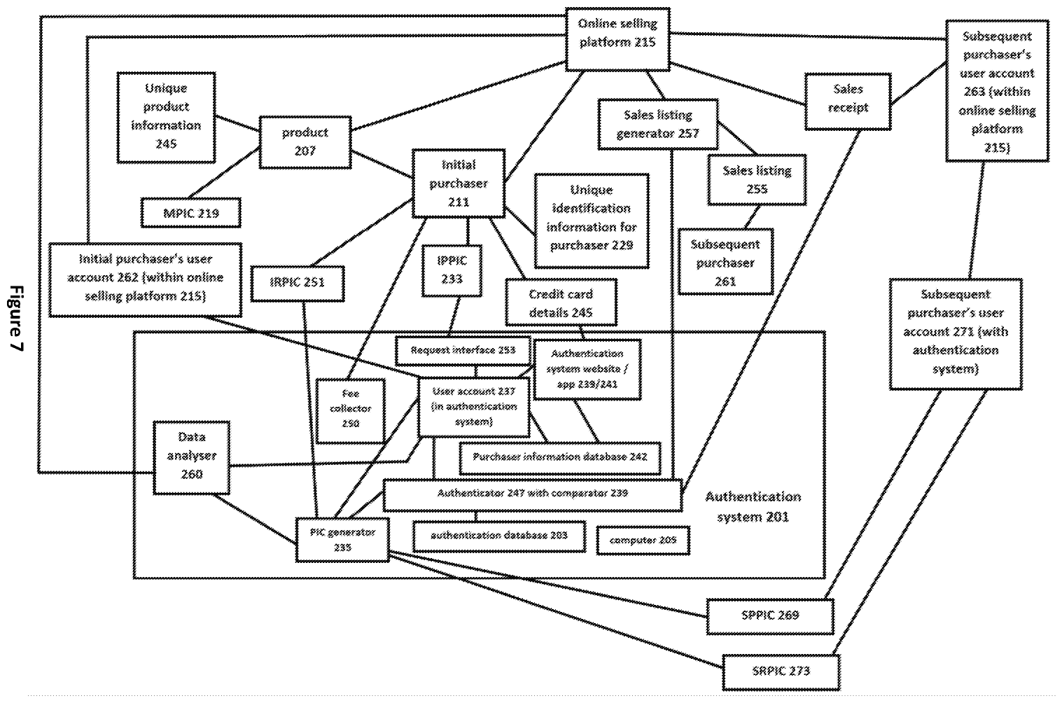

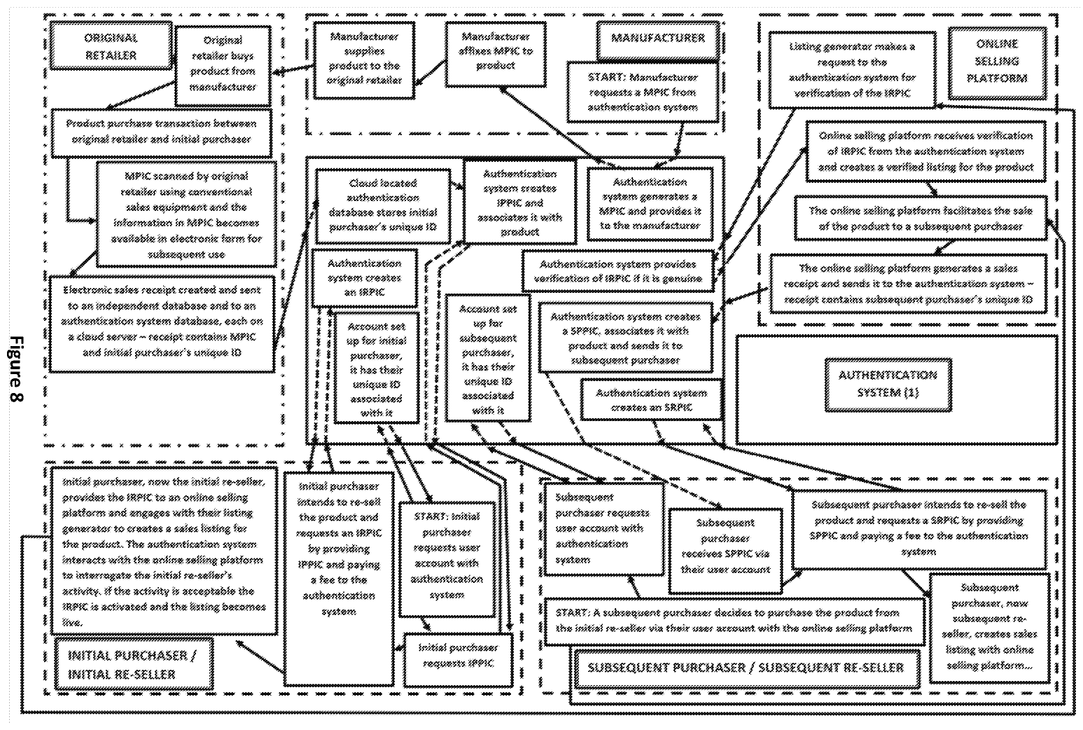

The authentication system 201 according to the second embodiment of the present invention is shown in FIGS. 5, 6, 7 and 8. The authentication system 201 includes a database 203 and an operating system that is implemented by a central computer 205 that is located remotely to the entities interacting with the authentication system. The entities are each provided with an interface into which they can enter information for use by the authentication system 201 and from which they can receive information produced by the authentication system 201. The interface can be provided on a website or on an app.

The second embodiment of the present invention described here involves six discrete entities and the authentication system 201 itself. The authentication system 201 permits the tracking of transactions associated with an authentic product 207 throughout the life of that authentic product 207, from the time of the completion of its manufacture, through a first sale transaction, between an original retailer 209 and an initial purchaser 211, to any subsequent re-sale of the product by the initial purchaser 211 to a subsequent purchaser 213 via on online selling platform 215 that is linked to the authentication system by a re-selling interface 216.

The process starts with a manufacturer 217 manufacturing a product 207. The manufacturer 217, upon completion of manufacture, allocates to that product 207 a unique Manufacturer's Product Identification Code, otherwise known as a Manufacturer's PIC (or MPIC) 219. The Manufacturer's PIC 219 is generated by a product identification code generator 235 which is a component part of the authentication system 201. The Manufacturer's PIC 219 is unique to the product 207 and is affixed to it using a printed label 223 (or it may be inscribed or stamped into the product 207).

The manufacturer 217 supplies the product 207 to an original retailer 209 and subsequently the original retailer 209 transacts a sale of the product 207 to an initial purchaser 211. The Manufacturer's PIC 219 is swiped or scanned during the transaction, using the original retailer's normal sales equipment 225, so that the information contained in the Manufacturer's PIC 219 becomes available in an electronic form for subsequent use. The transaction creates an electronic sales receipt 227 which includes detailed information about the product 207 that has been sold, the Manufacturer's PIC 219, unique identification information 229 for the purchaser 211 unique to the initial purchaser 211, such as their credit card number with some digits redacted, and information stating that the sold product is a product authenticated by the authentication system. The redaction and encryption of numbers from the credit card number is undertaken automatically by a purchaser code generator 231. This electronic sales receipt 227 is automatically transmitted to a sales transaction database that is not part of the authentication system 201, for example an independent database stored on a cloud server. In addition the electronic sales receipt 227 is transmitted to a cloud based authentication database 203 of the authentication system 201, because the software of the original retailer's normal sales equipment 225 has recognised that the sales receipt 227 relates to a product 207 with a Manufacturer's PIC 219 and that is being sold in associated with the authentication system 201. The authentication system 201 responds by storing the unique identification information 229 for the purchaser 211 and the Manufacturer's PIC 219 in its authentication database 203 and by creating a new code called an Initial Purchaser's PIC (IPPIC) 233 utilising the product identification code generator 235. The Initial Purchaser's PIC 233 is associated with the product 207 and replaces the Manufacturer's PIC 219. The Manufacturer's PIC 219 is then defunct and it is not used for any subsequent transactions during the life of the product 207, unless the product 207 has been gifted, or transferred, as dealt with later in this description. The Initial Purchaser's PIC 233 is not provided to the manufacturer 217 or to the original retailer 209 associated with the transaction, but it can be provided to the initial purchaser 211, as will be explained below.

If the initial purchaser 211 wants to verify that the purchased product 207 is genuine and/or if the initial purchaser 211 is minded to sell the product 207 in the future, then the initial purchaser 211 can actively engage with the authentication system 201 by opening a user account 237 on the authentication system 201, for example via the authentication system's website 239, or more usually via the authentication system's app 241. To create the user account 237 the initial purchaser 211 submits their credit card details 245, i.e. personal information that uniquely identifies them. That unique identification information 229 for the purchaser 211 is stored in a purchaser information database 242 within the authentication system 201.

Once the initial purchaser 211 has a user account 237 they can request the Initial Purchaser's PIC 233 by using the request interface 253. To obtain the Initial Purchaser's PIC 233 the authentication system 201 already has the Initial Purchaser's ID information 229 because the initial purchaser 211 provided their credit card details 243 when setting up their user account 237 with the authentication system 201. The unique product information 245 is obtained by use of an authenticator 247 which is a component of the authentication system 201. The authenticator 247 analyses the Manufacturer's PIC 219 and identifies the information that identifies that unique product 207. That information is typically a unique serial number. The authentication system 201 now has a first set of information relating to both the initial purchaser 211 and the product 207. The authentication system 201 now interrogates the electronic sales receipts 227 within the authentication database 203 to find a match for the unique product 207. The matched sales receipt 227 will also contain the personal identification information 229 for the purchaser 211. A comparator 249 connected to the authenticator 247 compares the initial purchaser's personal identification information 229, as provided directly to the authentication system 201 by the initial purchaser 211 when setting up their user account 237, with the initial purchaser's personal identification 229 as contained within the electronic sales receipt 227 that was sent to the authentication database 203 as a result of the initial sales transaction with the original retailer 209. If the comparison finds that the two sets of initial purchaser's identification information 229 match then the authentication system 201 will transmit an Initial Purchaser's PIC 233 to the initial purchaser 211 using a transmission device 230, such as the internet. The Initial Purchaser's PIC 233 enables the initial purchaser 211 to subsequently obtain an Initial Re-seller's PIC (IRPIC) 251, as will be explained below. The Initial Purchaser's PIC 233 thus includes the specific credit card payment system information 229 for the initial purchaser 211 that was used in the original transaction.

If the initial purchaser 211 decides that they wish to sell their product 207 then they will apply to the authentication system 201 for an Initial Re-seller's PIC 251. The initial purchaser 211 then becomes the initial re-seller 211. The initial re-seller 211 enters their Initial Purchaser's PIC 233 into the request interface 253 of the authentication system 201. The authenticator 247 in the authentication system 201 identifies the unique identification information 229 for the initial purchaser 211 that is contained in the Initial Purchaser's PIC 233 and using the comparator 249 compares it with the initial purchaser's identification information 229 stored in the initial purchaser's user account 237 with the authentication system 201. If the two sets of purchaser identification information 229 match and the initial re-seller 211 has paid a fee to the authentication system 201 using a fee collector 250, then the authentication system 201 will provide the initial re-seller 211 with the Initial Re-seller's PIC 251 in an inactive form. The initial re-seller 211 can then engage with an online selling platform 215 with the intention of creating a listing 255 using a sales listing generator 257 in order to advertise the product 207 for sale. However, the listing cannot be created without activating the Initial Re-Seller's PIC 251. In order for the Initial Re-seller's PIC 251 to become active, the user account 237 on the authentication system 201 that belongs to the initial re-seller 211 must be linked to the user account 262 that the initial re-seller 211 has on the online selling platform 215. The authentication system 201 will interact with the online selling platform 215 to interrogate the activity that the initial re-seller 211 has undertaken through the online selling platform 215. The interrogation is undertaken by a data analyser 260 that forms part of the authentication system 201. The data analyser 260 sends a request to the online selling platform 215 and the online selling platform 215 provides information relating to the activity of the initial re-seller, such as the type of products sold, the quantity of products sold and the location of the sales. The data analyser 260 analyses that information and makes a decision based upon the content of that information. The data analyser 260 communicates that decision to the product identification code generator 235 and to the user account 237 on the authentication system 201 that belongs to the initial re-seller 211. If that activity is deemed to be acceptable by the data analyser 260 then the product identification code generator activates the Initial Re-seller's PIC 251. If the activity is not deemed to be acceptable then the Initial Re-seller's PIC 251 will not be activated. If the Initial Re-seller's PIC 251 is not activated then the product identification code generator 235 will delete the Initial Re-Seller's PIC 251, and/or the Initial Purchaser's PIC 233 from the user account 237 on the authentication system 201 that belongs to the initial re-seller 211. If the Initial Re-seller's PIC 251 is activated by the product identification code generator 235 then that active Re-seller's PIC 251 will facilitate creation by the initial re-seller 211 of a listing 255 on the online selling platform 215. A chain has now been formed between the Manufacturer's PIC 219, the Initial Purchaser's PIC 233 and the Initial Re-seller's PIC 251, such that only the initial purchaser/the initial re-seller 11 could be in possession of and/or have access to the Initial Re-seller's PIC 251. The initial purchaser 211 and the initial re-seller 211 are in many cases the same person/entity, but the authentication system 201 can deal with instances in which they are separate entities or people, for example if the product 207 has been purchased as a gift. That situation is explained in a separate section of this description provided below.

The sales listing generator 257 of the online selling platform 215 interacts with the authenticator 247 of the authentication system 201. During the creation of the sales listing 255, the sales listing generator 257 will request that the initial re-seller 211 enters their Initial Re-seller's PIC 251. The sales listing generator 257 will interact with the authentication system 201 and send the IRPIC 251 to the authentication system 201 in order to verify if the Initial Re-sellers's PIC 251 is genuine. Verification is made of both the initial re-seller's identification information 229 and the unique product information 245. In relation to the initial re-seller's identification information 229, the authenticator 247 in the authentication system 201 will identify the unique identification information 229 for the initial re-seller 211 that is contained within the IRPIC 251 and using the comparator 249 compare it with the initial re-seller's identification information 229 that is stored in the initial re-seller's user account 259 with the online selling platform 215. If the two sets of re-seller's information 229 are the same then the first stage of the verification is complete. The second stage is to check the product information in the sales listing 255 against the unique product information 245 in the IRPIC 251. If the product information matches then the authentication system 201 will inform the online selling platform 215 that the IRPIC 251 is genuine. The listing 257 will become a verified listing, i.e. the listing 257 is for being made by an entity that has previously purchased a genuine product 207 of the type being advertised for sale.

If a subsequent purchaser 261 is found for the product 207 via the sales listing 255 then the initial re-seller 211 will transact a sale with the subsequent purchaser 261, via the online selling platform 215. Typically, the subsequent purchaser 261 will pay for the product 207 using a pre-registered credit or debit card, or with another form of payment, such as a PayPal account. This is information that is already associated with the online selling platform user account 263 of the subsequent purchaser 261. The online selling platform 215 will generate a sales receipt 265. The sales receipt 265 will include the subsequent purchaser's credit card, debit card, or other payment method information 267, with some information redacted, e.g. some of the credit card numbers, and the subsequent purchaser's resale account information, e.g. name, telephone number and/or e-mail address (i.e. information sufficient to meet required identification criteria). The online selling platform 215 will interact with the authentication system 201 by sending the sales receipt 265 to the authentication system 201. The authentication system 201 will respond by creating a Subsequent Purchaser's PIC (SPPIC) 269. The Subsequent Purchaser's PIC 269 replaces the Initial Re-seller's PIC 251 and the Initial Re-seller's PIC 251 is defunct.

If the subsequent purchaser 261 has a user account 271 with the authentication system 201, then that user account 271 can be linked with the subsequent purchaser's online selling platform account 263 to enable the Subsequent Purchaser's PIC 269 to be sent automatically to the subsequent purchaser 261 (and to no-one else). The Subsequent Purchaser's PIC 269 will then have the details of the product 207, the transaction history and the personal identification information 267 for the current owner (i.e. the subsequent purchaser 261). The Subsequent Purchaser's PIC 269 does not become active until the subsequent purchaser's user account 263 with the online selling platform 215 is linked with the subsequent user's user account 271 with the authentication system 201. If the subsequent purchaser 261 does not have an account with the authentication system 201 then the Subsequent Purchaser's PIC 269 is sent to the subsequent purchaser 261, for example via e-mail as part of their electronic sales receipt 265. The Subsequent Purchaser's PIC 269 only becomes active when the Subsequent Purchaser 261 downloads the authentication system app 241 and links their authentication system user account 271 to their user account 263 on the online selling platform 215. If the subsequent purchaser 261 already has a user account 271 in the authentication system 201 that is linked to their online selling platform account 263 then the process is simplified because the transaction is automatically associated with the subsequent purchaser's two user accounts 263,271. An active version of the Subsequent Purchaser's PIC 269 would be generated and issued to the subsequent purchaser 261 using the authentication system 201.

If the subsequent purchaser 261 does not have a user account 271 with the authentication system 201, then an incomplete and inactive version of the Subsequent Purchaser's PIC 269 is provided to the subsequent purchaser 261 as part of the electronic sales receipt 265. The Subsequent Purchaser's PIC 269 can be completed and made active, for example to enable use for future re-selling activity, by the subsequent purchaser 261 obtaining a user account 271 for the authentication system 201 and by entering their personal identification information 267 and/or by linking that authentication system user account 271 to their user account 2263 for the online selling platform 15.

The Subsequent Purchaser's PIC 269 provides to the subsequent purchaser 261 a verification that they are the rightful owner of the authentic version of the product and it enables the subsequent purchaser 269 to subsequently obtain a Subsequent Re-seller's PIC 273.

The Subsequent Re-seller's PIC 273 is used in the same way as the Initial Re-sellers PIC 251, such that numerous sales of a product 207 can occur throughout a product's life whilst all the time being able to maintain a chain of ownership back to the initial purchaser 211 of a genuine product 207.

If the initial purchaser 211 and the initial re-seller 211 are not the same person, for example the initial purchaser 211 has bought the product 207 as a gift for another person, then the person to whom the product 207 has been gifted can engage with the authentication system 201 if they wish to, for example to obtain an Initial Re-seller's PIC 251. The initial purchaser 211 will need to have a user account 237 with the authentication system 201 and using that user account 237 they will facilitate the generation of the Initial Purchaser's PIC 233, because the authentication system 201 will have the product details 245 and the personal identification details 229. The person to whom the product 207 has been gifted, referred to from now on as the transferee, will also need to have a user account with the authentication system 201 and they can, through that user account, request a product transfer by entering the Manufacturer's PIC 219 into the authentication system 201. The authentication system 201 will then ask the initial purchaser 211 to confirm that the product transfer has taken place.

In the preferred embodiment described above, the initial purchase of the new product 207 is made in a physical store, e.g. a shop on a high street. Alternatively, the initial purchase could be made in an online store, as will be explained below.

The initial purchaser 211 will buy a product 207 from an online store using a credit card, or an online payment system such as PayPal. The transaction generates a sales receipt 227 which includes the initial purchaser's credit card or online payment system account details 229, with various pieces of information redacted, and the initial purchaser's contact details, e.g. name, postal address, telephone number and e-mail address. The sales receipt 227 is sent to the authentication system 201 and thus the authentication system 201 receives the payment details, e.g. credit card details. The Initial Purchaser's PIC 233 is generated and if the initial purchaser 211 has a user account 237 with the authentication system 201 then the Initial Purchaser's PIC 233 is sent to that user account 237. The Initial Purchaser's PIC 233 does not become active until the user account 237 in the authentication system 201 and the user account in the online store are linked. If the Initial Purchaser 211 does not have a user account 237 with the authentication system 201 then the Initial Purchaser's PIC 233 is sent to the initial purchaser 211 with the sales receipt 227, e.g. by e-mail. The Initial Purchaser's PIC 233 becomes active when the initial purchaser 211 opens a user account 237 with the authentication system 201 and links it to the online store user account. If the initial purchaser 211 already has a user account 237 in the authentication system 201 that is linked to their online selling platform account then the process is simplified because the transaction is automatically associated with the initial purchaser's two user accounts. An active version of the Initial Purchaser's PIC 233 would be generated and issued to the initial purchaser 211 using the authentication system 201.

In an alternative arrangement, there is no need to make a link between the user account 237 in the authentication system 201 and the user account in the online store in order for the initial purchaser 211 to obtain an active Initial Purchaser's PIC. If the initial purchaser 211 does not have a user account 237 with the authentication system 201 the initial purchaser can purchase the product 207 online, receive it and subsequently obtain a user account 237 with the authentication system 201, enter the Manufacturer's PIC 219 via the website or app 239,241 and then obtain the IPPIC 233.

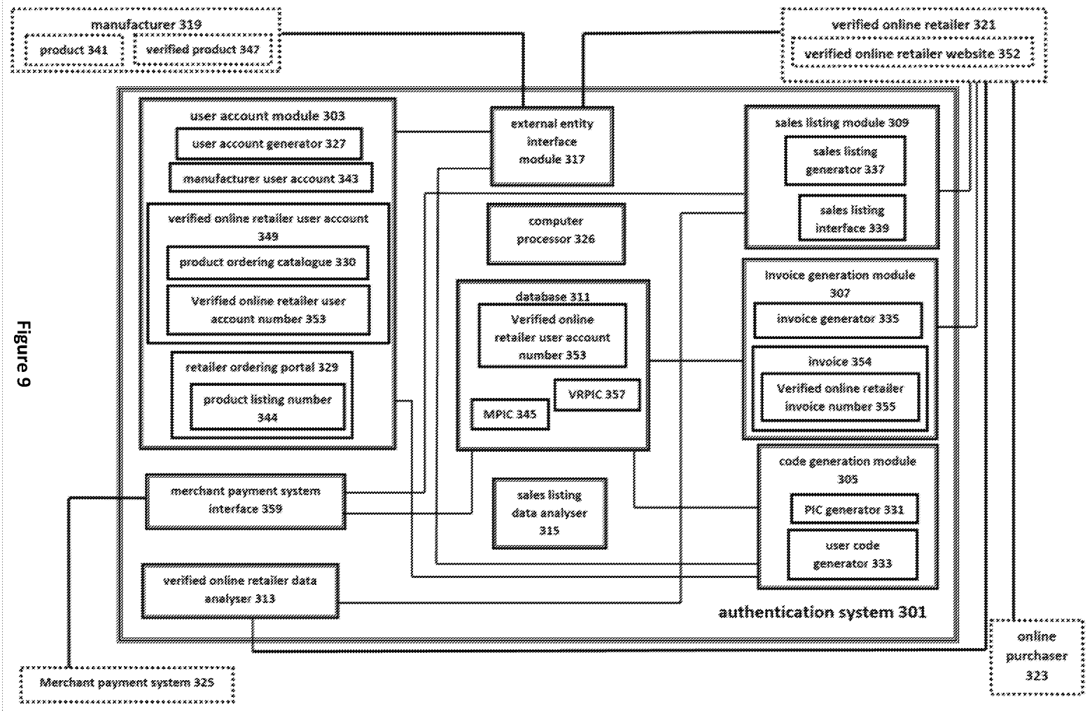

The authentication system 301 according to the third embodiment of the present invention is shown in FIG. 9. It comprises a user account module 303, a code generation module 305, an invoice generation module 307, a sales listing module 309, a cloud database 311, a verified online retailer data analyser 313 and a sales listing data analyser 315. The authentication system 301 also has an external entity interface module 317, provided on a website or an app, which is designed to interact with a manufacturer 319, a verified online retailer 321, an online purchaser 323 and a merchant payment system 325. A computer processor 326 is provided to facilitate the operation of the various components of the authentication system 301.

The user account module 303 has a user account generator 327 and a retailer ordering portal 329. User accounts are stored within the user account module 303. The user accounts may contain additional information such as a product ordering catalogue 330.

The code generation module 305 has a product information code generator, or PIC generator, 331 and a user code generator 333.

The invoice generation module 307 has an invoice generator 335. Invoices generated by the generator 335 are stored in the user accounts within the user account module 303.

The sales listing module 309 comprises a sales listing generator 337 and a sales listing interface 339.

Data connections are provided between the database 311 and the user account module 303, the code generation module 305 and the invoice generation module 307, so that the database 311 can receive information from each of the modules 303, 305, 307 and 309 and store that information.

The modules 303, 305, 307 and 309 are interlinked with data connections that enable the modules to communicate with each other, as described below. Data connections are also provided between the modules 303, 305, 307 and 309 and an external entity interface 317 and the manufacturer 319, the verified online retailer 321 and a merchant payment system interface 359 for the merchant payment system 325. The merchant payment system interface 329 is linked to each of the sales listing module 309 and the database 311 by a data connection.

The implementation of the authentication system 301 in relation to a manufactured product 341 is described below, from the point of manufacture of the product 341 to the sale of the product to the online purchaser 323.

The manufacturer 319 manufactures the product 341 and wishes to sell that product to the online retailer 321 using the authentication system 301. The online retailer will in turn sell the product to the online purchaser 323, also by using the authentication system 301.

In order to utilise the authentication system 301, the manufacturer 319 makes a request for a manufacturer user account 343 via the external entity interface 317. The external entity interface 317 sends that request to the user account module 303 and the user account module 303 creates the manufacturer user account 343 within the authentication system 301.

The user account 343 facilitates the manufacturer 319 in making a request for a manufacturer's product identification code, or MPIC, 345 for the product 341. The user account module 303 sends a request to the code generation module 305 and the code generation module 305 instructs the PIC generator 331 to create the MPIC. The code generation module 305 sends the MPIC 345 to the user account module 303 from where it is communicated to the manufacturer 319 via the manufacturer user account 345. The code generation module 305 also sends the MPIC 345 to the database 311 where it is stored for future use. The product 341 has now become a verified product 347, i.e. a product that has been verified by the authentication system 301 as being an authentic product of the manufacturer 319. The manufacturer 319 can now use the authentication system 301 to list the verified product 347 for sale to any verified online retailer 321 via the product ordering catalogue 330. Each individual verified product 347 has a unique MPIC 345. Verified products 347 are likely to be made in quantities, for example of one hundred or one thousand. In order to avoid listing each of the verified products 347 separately within the product ordering catalogue 330, which would create a very long and unwieldy catalogue 330, each product type is identified by a product listing number 344. If a manufacturer 319 makes a batch of the same products 341, then a request can be made for a unique MPIC 345 for each of the products 341 in the batch.

A verified online retailer 321 is any online retailer that has a verified online retailer user account 349 within the authentication system 301. To obtain a verified online retailer user account 349 an online retailer makes a request for a verified online retailer user account 343 via the external entity interface 317. The online retailer submits their unique identification information, for example their company registration information, and also the account information for the payment system that they will be using to pay for their purchase of a product 341 from the manufacturer 319. That unique identification information is passed from the external entity interface 317 to the code generation module 305. The code generation module 305 requests that the user code generator 333 creates a user code 351 for the verified online retailer 321 that is either a redacted or an encrypted version of their unique identification information. The code generation module 305 then sends that code to the user account module 303. The external entity interface 317 also sends the online retailer's request to the user account module 303 and the user account module 303 then creates the verified online retailer user account 343 within the authentication system 301 on the basis of that request and the existence of the user code 351. The verified online retailer 321 is provided with a verified online retailer account number 349 which is stored in the database 311.

Creation of the verified online retailer user account 349 enables the verified online retailer website 352 to be linked both to the sales listing module 309 and to the verified online data analyser 313 of the authentication system 301.

The product ordering catalogue 330 is provided within the verified online retailer user account 349. The verified online retailer 321 selects the verified product 347 within the catalogue 330 and places an order via the retailer ordering portal 329. The user account module 303 relays that order and the product listing number 344 to the manufacturer 319 via the manufacturer user account 343 along with the verified online retailer account number 349. The manufacturer 319 confirms the order to the user account module 303, via an encrypted order confirmation request sent to the ordering portal 329, and the user account module 303 sends a request to the invoice generation module 307 for the generation of an invoice. The invoice generator 335 matches the product listing number 344 to one or more MPICs 345 within the database 311, dependent upon whether the order is for just one product, or for multiple products, and generates an invoice 354 having a verified online retailer invoice number 355 which contains all of the information pertinent to the order, such as the order date, the payment information for the verified online retailer 321, or just the user code 351, and the one or more MPICs 345. The verified online retailer invoice number 355 contains the invoice in redacted or encrypted form. This enables the authentication system 301 to only release the information that it wants to release, and keep secret other information, such as an MPIC 345. The retailer ordering portal 329 sends a final confirmation request to the verified online retailer 321 via the user account 349 of the verified online retailer 321 so that the verified online retailer 321 can make a final confirmation of the order. The final confirmation request includes the invoice 354 and the verified online retailer invoice number 355. The final confirmation request is in the form or a code sent to a mobile telephone or e-mail account of the verified online retailer 321. The verified online retailer 321 will then submit that code to the invoice generation module 307 via the verified online retailer user account 349 and it is thereby confirmed that the transaction has been made.

Upon receipt of confirmation of the transaction, the authentication system 301 is now used to create a verified retailer's product identification code, or VRPIC, 357. If the transaction relates to multiple products of the same type, then a unique VRPIC 357 will be created for each of those products.

In the first instance, the VRPIC 357 is created in an inactive form. The invoice generation module 307 instructs the PIC generator 331 to create the VRPIC 357. The PIC generator 331 generates the inactive VRPIC 357 by combining the verified online retailer invoice number 355 with the verified online retailer account number 349. The VRPIC 357 is therefore specific to a particular verified online retailer 321. The code generation module 305 communicates with the database 311 so that the inactive VRPIC 357 can be saved within it. The user account module 303 sends a verification request to a mobile telephone or e-mail account of the verified online retailer 321. The verified online retailer 321 will then submit that code to the user account module 305 via their verified online retailer user account 349. The user account module 305 will then instruct the code generation module 305 to send the VRPIC 357 to the sales listing module 309.

The verified online retailer 321 now has the verified product 347 and they wish to list it for sale on their verified online retailer website 352. In order to list the verified product 347 for sale via the authentication system 301 the verified online retailer 321 makes a listing request via their verified online retailer user account 349. The user account module 303 communicates the sales listing to the sales listing module 309. The sales listing module 309 is now made aware that there is an active online sales listing for the verified product 347 and thus activates the VRPIC 357.

The active sales listing is also communicated to the verified online retailer data analyser 313 by the sales listing module 309. The verified online retailer data analyser 313 then checks to see if the verified online retailer 321 has any sales listings for other products manufactured by the manufacturer 319, which products have no VRPIC 357.

The sale of a verified product 347 via the verified online retailer website 352 is initiated when the online purchaser 323 adds the verified product 347 to their cart or when the online purchaser 323 confirms their payment. The sales listing module 309 is made aware of the initiation of the transaction, because it is connected to the verified online retailer website 352. The sales listing module 309 then informs the merchant payment system 325 about the transaction via a merchant payment interface 359.

The sales listing module 309 sends the VRPIC 357 for the verified product 347 to a merchant payment system interface 359. The merchant payment system interface 359 alerts the merchant payment system 325 that it will be receiving an instruction. This instruction will be sent prior to the merchant payment system 325 processing the transaction between the online purchaser 323 and the verified online retailer website 352. The information provided to the merchant payment system 325 from the sales listing module 309, via the merchant payment system interface 359, enable the merchant payment system 325 to know the identity of the verified online retailer 321 that is using the verified online retailer website 352. The information from the sales listing module 309 can include the IP address of the verified online retailer website 352. The merchant payment system interface 359 interrogates the database 311 to see if the VRPIC 357 for the verified product 347 is present within it. If the VRPIC 357 is present in the database 311 then the merchant payment system interface 359 will instruct the merchant payment system 325 to authorize the transaction and the VRPIC 357 will be removed from the database 311. If the VRPIC 357 is not present in the database 311 then the merchant payment system interface 329 will notify the merchant payment system 325 that this is the case. The merchant payment system 325 will then block, or suspend the transaction, or notify the online purchaser 323 that the authenticity of the product 341 cannot be verified.

A general data analysis of online sales can be conducted by the authentication system 301 using its sales listing data analyser 315. The sales listing data analyser 315 analyses the online selling platforms of online retailers, whether or not those retailers have been verified by the authentication system 301. The authentication system 301 instructs the data analyser to look for product sales listings of a manufacturer's products using a number of indicators. If the sales listing data analyser 315 identifies a manufacturer's product for sale it informs the authentication system 301 and transmits the indicators and the information to identify the online seller. This enable identification of the specific product sales listing. The authentication system 301 stores the indicators in the database 311 and informs the merchant payment system 325, so that it is aware that the online seller may be selling counterfeit products. If a transaction is initiated with the online retailer the data analyser analyses the transaction and looks for indicators of the same type that were stored in the unverified product listing database. If any indicators are identified by the sales listing data analyser 315 they are passed to a comparator 361 in the authentication system 301. The comparator 361 compares the indicators from the sales listing data analyser 15 with the indicators stored in the database 311. If there is a match with the indicators in the database 311 then the authentication system 301 asks the merchant payment system 325 to request a VRPIC 357 from the online seller. If the online seller cannot supply a VRPIC 357 then the merchant payment system 325 will block, or suspend the transaction, or notify the online purchaser 323 that the authenticity of the product 341 cannot be verified.

1. An authentication system comprising:
(a) a unique Manufacturer's Product Identification Code (MPIC) containing information to identify a unique product of a plurality of products;
(b) a unique purchaser code containing information to identify an individual purchaser of a plurality of purchasers, that information relating to the individual purchaser's mode of payment;
(c) a combined code generator for generating a unique combined code;
(d) an authentication database for receiving and storing product information identifying the unique product of the plurality of products and for receiving and storing the unique purchaser code, both the product information and the unique purchaser code associated with the sale of the unique product and recorded in a sales receipt;
(e) a unique combined code request interface;
(f) a purchaser code database for receiving and storing the unique purchaser code relating to a purchaser's mode of payment;
(g) an authenticator for authenticating a request for the unique combined code, the authenticator capable of authenticating a request from the individual purchaser for the unique combined code that contains information from the MPIC that is associated with the unique product of the plurality of products purchased by the individual purchaser of the plurality of purchasers and information from the unique purchaser code of the individual purchaser of the plurality of purchasers, the unique combined code known as an Initial Purchaser's Product Identification Code (IPPIC), the authenticator being connected to the authentication database, to the unique combined code request interface and to the purchaser code database and comprising a comparator, wherein to authenticate a request for the IPPIC the comparator compares information within the MPIC provided by the individual purchaser of the plurality of purchasers, via the unique combined code request interface, with the product information associated with the sales receipt as stored in the authentication database, in order to find a match with a product code contained within the sales receipt thereby to identify the unique product, wherein the comparator then compares the unique purchaser code for that sales receipt with the unique purchaser code for the individual purchaser as contained in the purchaser code database; and
(h) if the comparator finds that the unique purchaser code for the sales receipt matches the unique purchaser code for the individual purchaser making the request for the IPPIC then the combined code generator will generate the IPPIC and the authentication system will issue the generated IPPIC to the individual purchaser.

2. The authentication system as claimed in claim 1 wherein the authenticator is capable of authenticating the request from the individual purchaser for the Initial Re-seller's Product Identification Code (IRPIC) made via the unique combined code request interface, the individual purchaser entering the IPPIC for the unique product into the unique combined code request interface, wherein to authenticate the request for the IRPIC the comparator compares the purchaser code within the IPPIC with the unique purchaser code for the individual purchaser that is stored in the purchaser code database and if the unique purchaser code within the IPPIC and the unique purchaser code within the purchaser code database match then the combined code generator will generate the IRPIC and the authentication system will issue the IRPIC to the individual purchaser.

3. The authentication system as claimed in claim 2 further comprising:
(a) a re-selling interface for interacting with a re-selling platform; wherein the authenticator is capable of authenticating a request for a verification of the IRPIC made by the re-selling platform via the re-selling interface, wherein to authenticate the request for a verification of the IRPIC the comparator first compares the unique purchaser code within the IRPIC with the unique purchaser code for the individual purchaser that is provided to the re-selling platform and second compares the product information provided to the authentication system by the re-selling platform with the product information in the IRPIC and if there is match for both the individual purchaser information and the product information (45,245) then the authentication system will authenticate the verification request received from the re-selling platform.

4. The authentication system as claimed in claim 1 wherein the combined code generator comprises a string generator for generating the unique combined code.

5. The authentication system as claimed in claim 1 wherein the combined code generator further comprises a transmitter for transmitting the unique combined code generated by the combined code generator to the individual purchaser or to a re-seller.

6. The authentication system as claimed in claim 1 further comprising a purchaser code generator, wherein the purchaser code generator generates the unique purchaser code by automatically redacting numbers from the identifying number for the individual purchaser's means of payment.

7. The authentication system as claimed in claim 1 further comprising a re-seller code generator, wherein the re-seller code generator generates a re-seller code by automatically redacting numbers from the identifying number for the re-seller's means of payment.

8. The authentication system as claimed in claim 1 further comprising a Manufacturer's Product Identification Code (MPIC) generator for generating the unique MPIC for the unique product.

9. The authentication system as claimed in claim 1 further comprising a payment receipt interface, wherein, in use, the individual purchaser or a re-seller can uses the payment receipt interface to make a payment to the authentication system in order to purchase the unique combined code.

10. The authentication system as claimed in claim 1 further comprising a sales interface, wherein in use, a retailer uses the sales interface to provide the MPIC and the unique purchaser code directly to the authentication database.

11. The authentication system as claimed in claim 1 further comprising an electronic sales receipt generator.

12. The authentication system as claimed in claim 1 further comprising a user account generator for generating a user account for the individual purchaser.

13. The authentication system as claimed in claim 1 wherein the authentication database is located on a cloud based server.

14. The authentication system as claimed in claim 1 located on a cloud based server.

15. The authentication system as claimed in claim 3, wherein the re-selling platform is an online selling platform.

16. An online transaction monitoring system comprising:
a user account module;
a code generation module;
an invoice generation module;
a sales listing module;
a database;
a verified online retailer data analyser that is connectable to a verified online retailer website and that is linked to the sales listing module by a data connection;
an external entity interface module;
a computer processor;
a merchant payment system interface that is linked to each of the database and the sales listing module by the data connection; and
wherein the merchant payment system interface is connectable to a merchant payment system (325).

17. The online transaction monitoring system as claimed in claim 16 wherein:
the user account module comprises a user account generator and a retailer ordering portal;
the code generation module comprises a PIC generator and a user code generator;
the invoice generation module comprises an invoice generator; and
the sales listing module comprises a sales listing generator and a sales listing interface.

18. The online transaction monitoring system as claimed in claim 16, further comprising a sales listing data analyser.

19. The online transaction monitoring system as claimed in claim 16, wherein the database contains a unique manufacturer product identification code and a unique verified product identification code (VRPIC), wherein the VRPIC contains information to identify a unique verified product.
